(19) United States
(12) Patent Application Publication
(10) Pub. No.: US 2009/0020976 A1
(43) Pub. Date: Jan. 22, 2009

(54) Bushing having high axial spring rate and method of manufacturing

(75) Inventor: Jeremy D. Weilnau, Huron, OH (US)

Correspondence Address: HARNESS, DICKEY & PIERCE, P.L.C., P.O. BOX 828, BLOOMFIELD HILLS, MI, 48303, US

(73) Assignee: The Pullman Company, Milan, OH (US)

(21) Appl. No.: 11/879,199

(22) Filed: Jul. 16, 2007

(51) Int. Cl. B60G 15/02

(52) U.S. Cl. 280/124.164

(57) ABSTRACT

A high axial spring rate spring pivot bushing has an inner metal to which is press fit a ferrule at one end. An outer metal is disposed around the inner metal and an elastomeric bushing is located between the inner metal, the ferrule and the outer metal. The spring pivot bushing is manufactured by pressing the ferrule on the inner metal, placing the inner metal, ferrule and outer metal in a mold and then injecting an elastomeric material to create the elastomeric bushing.

### FIELD

The present disclosure relates to a bushing for a suspension system for a bus, a truck, an automobile or the like. More particularly, the present disclosure relates to a bushing for a suspension system which is designed with a high axial spring rate and a method of manufacturing the bushing.

### BACKGROUND

The statements in this section merely provide background information related to the present disclosure and may not constitute prior art.

Truck, bus and automotive suspensions are commonly designed using either a pair of leaf springs or at least a pair of control arms located between both the front and rear axles of the vehicle (the unsprung portion) and the body of the vehicle (the sprung portion).

The leaf springs are normally a plurality of arcuately shaped steel or composite leafs that are stacked together to form the leaf spring. The axle assembly of the vehicle is normally secured to the approximate center of the arcuate leafs with the ends of the leafs extending upwards. The upward ends of one of the leafs are normally formed into a tubular section or eye which is adapted for receiving a spring pivot bushing. The spring pivot bushing usually consists of an outer metal housing which is pressed into the eye of the leaf spring, a layer of elastomeric material positioned within the outer metal and an inner metal housing which extends through the center of the elastomeric material. A bolt or other fastener extends through the inner metal and secures the end of the leaf spring to the frame or to another component of the sprung portion of the vehicle by mating with an appropriate bracket. As the vehicle travels, relative movement between the sprung portion and the unsprung portion of the vehicle is accommodated by flexing of the leaf springs. The flexing of the leaf springs causes the ends of the leaf spring to pivot on both of the tubular sections or eyes which secure the leaf spring to the sprung portion of the vehicle.

The spring pivot bushing are utilized to facilitate this pivotal motion and also to isolate the sprung portion of the vehicle from the unsprung portion of the vehicle. In certain high load applications, it becomes advantageous to encapsulate the elastomeric material between the inner and outer metals. The encapsulating of the elastomeric member improves the axial retention, it improves the radial spring rate and it improves the durability of the spring pivot bushing.

Leaf springs have a tendency to walk off of the spring pivot bushing during the flexing of the suspension and the spring pivot bushing. Due to the design of the suspension systems, the leaf springs always attempt to walk off of the spring pivot bushings in the same direction.

### SUMMARY

The present disclosure details a spring pivot bushing and a method of manufacturing the spring pivot bushing. The spring pivot bushing comprises an inner metal, an outer metal and an elastomeric member disposed between the inner and the outer metals. The inner metal includes a ferrule which encapsulates the elastomeric member. The inner and outer metals are inserted into a mold cavity and the elastomeric member is injected into the space between the inner and the outer metals through injection apertures formed through the ferrule.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a typical rear suspension for a vehicle which incorporates the spring pivot bushing in accordance with the present disclosure;

FIG. 2 is an enlarged end view of the spring pivot bushing illustrated in FIG. 1;

FIG. 3 is a cross-sectional view of the spring pivot bushing illustrated in FIG. 2;

FIG. 4 is a cross-sectional schematic view of the molding method for the spring pivot bushing illustrated in FIG. 2; and

FIG. 5 is an enlarged end view similar to FIG. 3 but illustrating a spring pivot bushing in accordance with another embodiment of the present disclosure.

### DETAILED DESCRIPTION

The following description is merely exemplary in nature and is not intended to limit the present disclosure, application, or uses.

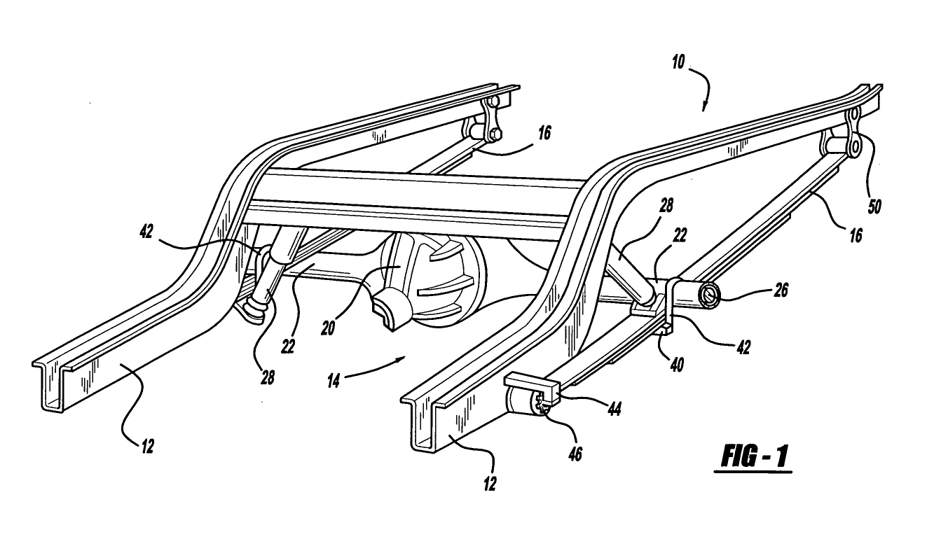

Referring now to the drawings in which like reference numerals designate like or corresponding parts throughout the several views, there is shown in FIG. 1, a truck, bus, trailer or automotive suspension incorporating a spring pivot bushing in accordance with the present disclosure and which is designated generally by the reference numeral 10. Suspension 10 comprises a frame 12, a drive axle assembly 14 and a pair of leaf springs 16. Frame 12 is part of and supports a body (not shown) and other components of the vehicle which are generally identified as the sprung portion or sprung mass of vehicle 10. Drive axle assembly 14 comprises a differential 20 which receives a driving force from an engine (not shown) through a rotating propeller or drive shaft (not shown). Drive axle assembly 14 further comprises a pair of hollow tubes 22 that each extend out to a respective wheel assembly (not shown). Disposed within each of tubes 22 is a drive axle 26 that extends from differential 20 to a respective wheel assembly. The engine transmits a drive force to differential 20 through the propeller or drive shaft. Differential 20 transfers the drive force from the propeller or drive shaft to drive axles 26 to rotate and thus drive the wheel assemblies of vehicle 10. Leaf springs 16 are disposed between frame 12 and drive axle assembly 14 as will be discussed later herein. Additionally, a shock absorber 28 is disposed between each rail of frame 12 and drive axle assembly 14 to dampen the relative motion between these components. A torque rod (not shown) can be disposed between frame 12 and drive axle assembly 14 to assist in the control of the motion of drive axle assembly 14 with respect to frame 12.

Leaf springs 16 are each attached to a respective tube 22 using a spring plate 40 and a pair of spring clips 42. The front loop or eye of each leaf spring 16 is attached to a bracket 44 which is secured to frame 12. A spring pivot bushing 46 is disposed between the eye of leaf spring 16 and bracket 44 to accommodate motion between these two components and to isolate frame 12 from drive axle assembly 14. The rear loop or eye of each leaf spring 16 is attached to a shackle 50 which is disposed between frame 12 and the rear loop or eye of leaf spring 16. A spring pivot bushing 46 is disposed between leaf spring 16 and shackle 50 and a pivot bushing can be disposed between shackle 50 and frame 12 to accommodate motion between these components and to isolate frame 12 from drive axle assembly 14.

While the present disclosure is illustrated as having spring pivot bushing 46 located at three connecting points between frame 12, leaf spring 16 and drive axle assembly 14, it is within the scope of the present disclosure to have fewer than three spring pivot bushings 46 for each attachment and to replace one or more spring pivot bushings 46 with a different bushing. Finally, while the present disclosure is being illustrated as having shackle 50 disposed between the rear loop or eye of leaf spring 16 and frame 12, it is within the scope of the present disclosure to have shackle 50 between the front loop or eye of leaf spring 16 and frame 12, or to have bracket 44 disposed between the rear loop or eye of leaf spring 16 and frame 12.

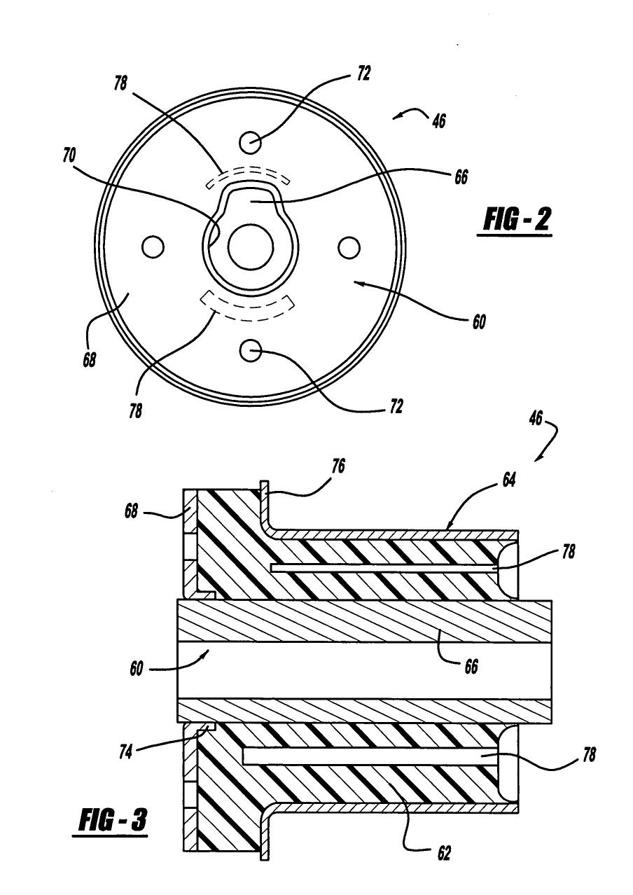

Referring now to FIGS. 2 and 3, spring pivot bushing 46 comprises an inner metal assembly 60, an elastomeric bushing 62 and an outer metal 64. Inner metal assembly 60 comprises an inner metal 66 and a ferrule 68 press fit or otherwise secured to inner metal 66.

Inner metal 66 is a tubular member which is non-circular in order to provide a different radial rate in different radial directions. FIG. 5 illustrates a spring pivot bushing 46′ which includes an inner metal 66′ which has a circular shape and thus will have the same radial rate in all radial directions. Ferrule 68 is an annular member which defines a central bore 70 which is contoured to mate with inner metal 66 and a plurality of injection apertures 72 through which elastomeric bushing 62 is injected as described below. Ferrule 68 is press-fit or otherwise secured to inner metal 66 and ferrule 68 defines an annular flange 74 which increases the area of contact between ferrule 68 and inner metal 66.

Outer metal 64 is a cylindrical member that includes an annular flange 76 which is positioned as illustrated in FIG. 3 to oppose ferrule 68. Elastomeric bushing 62 is disposed between inner metal assembly 60 and outer metal 64. Elastomeric bushing 62 defines one or more voids 78 which are sized, shaped and located to tune the rate of spring pivot bushing 46 to a specified rate.

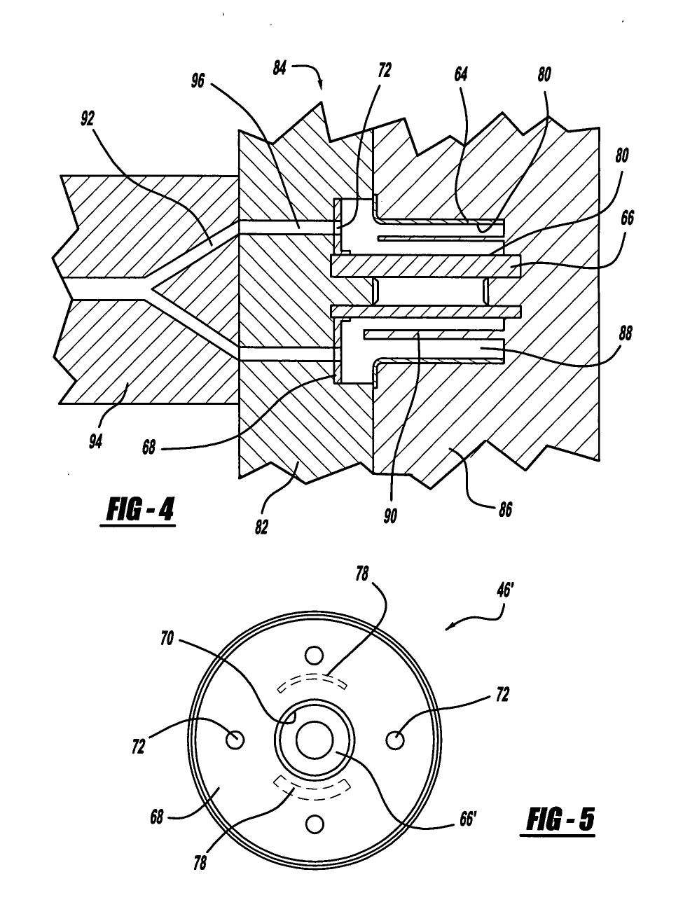

FIG. 4 illustrates the manufacturing process for spring pivot bushing 46. First, ferrule 68 is press-fit or otherwise secured to inner metal 66 to create inner metal assembly 60. Inner metal assembly 60 and outer metal 64 are coated with a bonding agent 80 which is designed to react with and bond elastomeric bushing 62 to inner metal assembly 60 and outer metal 64. Inner metal assembly 60 is inserted in a first mold 82 of a mold assembly 84 and outer metal 64 is inserted into a second mold 86 of mold assembly 84. Mold assembly 84 is then closed to form a mold cavity 88. Second mold 86 defines one or more mold extensions or inserts 90 which create the one or more voids 78.

Once mold assembly 84 is closed, as is illustrated in FIG. 4, an elastomeric material is injected into mold cavity 88 through a series of gates 92 formed in an injection head 94. Gates 92 are in communication with a plurality of gates 96 in first mold 82 and each of the plurality of gates 96 are in communication with a respective injection aperture 72 formed in ferrule 68. The injected elastomeric material creates elastomeric bushing 62 including voids 78. Elastomeric bushing 62 is bonded to inner metal assembly 60 and outer member 64 over its entire contact area with these components due to bonding agent 80 that was applied to inner metal assembly 60 and outer metal 64.

Referring now to FIG. 5, spring pivot bushing 46′ is illustrated. As detailed above, spring pivot bushing 46′ is the same as spring pivot bushing 46 except that inner metal 66 has been replaced by inner metal 66′. Inner metal 66′ is circular in shape to provide the same radial rate in all radial directions.

What is claimed is:

1. A pivot bushing comprising:
an inner metal defining a through hole;
a ferrule attached to an outer surface of said inner metal, said ferrule extending radially outward from said inner metal;
an outer metal disposed over said inner metal, said outer metal including a cylindrical portion surrounding said inner metal and a radially outward extending flange extending generally parallel to said ferrule; and
an elastomeric member bonded to said inner metal, said ferrule, said cylindrical portion of said outer metal and said radially outward extending flange of said outer metal.

2. The pivot bushing according to claim 1, wherein said ferrule is press fit to said inner metal.

3. The pivot bushing according to claim 1, wherein said inner metal has a non-circular outer shape.

4. The pivot bushing according to claim 1, wherein said inner metal has a circular outer shape.

5. The pivot bushing according to claim 1, wherein said ferrule defines an injection hole.

6. The pivot bushing according to claim 1, wherein said elastomeric member defines a void disposed between said inner and outer metals.

7. The pivot bushing according to claim 1, wherein an annular gap is defined between said ferrule and said flange of said outer metal, said elastomeric member completely filling said annular gap.

8. A method of manufacturing a pivot bushing comprising:
providing an inner metal;
assembling a ferrule to said inner metal;
placing said inner metal and said ferrule into a mold;
placing an outer metal into said mold such that the outer metal surrounds the inner metal; and
injecting an elastomeric material between said inner metal and said outer metal through an injection hole defined by said ferrule to form an elastomeric bushing.

9. The method of manufacturing a pivot bushing according to claim 8, wherein the step of providing said inner metal includes providing an inner metal with a non-circular outer surface.

10. The method of manufacturing a pivot bushing according to claim 8, wherein the step of providing said inner metal includes providing an inner metal with a circular outer surface.

11. The method of manufacturing a pivot bushing according to claim 8, wherein the step of assembling said ferrule to said inner metal includes press fitting said ferrule to said inner metal.

12. The method of manufacturing a pivot bushing according to claim 8, wherein the step of placing said inner metal and said ferrule in said mold includes placing the assembly of said inner metal and said ferrule in said mold.

13. The method of manufacturing a pivot bushing according to claim 8, wherein the step of placing said outer metal into said mold positions a flange defined by said inner metal generally parallel with said ferrule.

14. The method of manufacturing a pivot bushing according to claim 13, wherein the step of injecting said elastomeric material between said inner metal and said outer metal includes filling an annular gap between said ferrule and said flange defined by said outer metal.

15. The method of manufacturing a pivot bushing according to claim 14, further comprising bonding said elastomeric material to said inner metal, said ferrule and said outer metal.

16. The method of manufacturing a pivot bushing according to claim 8, further comprising bonding said elastomeric material to said inner metal, said ferrule and said outer metal.

17. The method of manufacturing a pivot bushing according to claim 8, further comprising positioning an insert between said inner and outer metals to define a void in said elastomeric bushing.

18. The method of manufacturing a pivot bushing according to claim 8, further comprising painting said inner metal, said ferrule and said outer metal with a bonding agent.
